(19) United States
(12) Patent Application Publication
(10) Pub. No.: US 2013/0152635 A1
(43) Pub. Date: Jun. 20, 2013

(54) PROCESS AND DEVICE OF THREE-DIMENSIONAL DEFORMATION OF PANELS, IN PARTICULAR GLASS PANELS

(71) Applicant: Miguel Tovar, Guadalajara (MX)

(72) Inventor: Miguel Tovar, Guadalajara (MX)

(21) Appl. No.: 13/412,865

(22) Filed: Mar. 6, 2012

(30) Foreign Application Priority Data
Dec. 17, 2011 (EP) 11009935.5

(51) Int. Cl. C03B 23/023

(52) U.S. Cl. 65/104; 65/268

(57) ABSTRACT

For improving a process of three-dimensional deformation of glass panes, said glass panes

a) are heated up to the softening temperature in a first step
b) are deformed in a second step, and
c) are prestressed by means of targeted cooling in a third step,
wherein the process steps are subsequently applied to individual successive treatment segments of the panel to be deformed in such a manner that different subsequent treatment segments of the panel are treated effectively in another process step at the same time, wherein subsequent treatment segments for example are heated up to the processing temperature, while preceding treatment segments for example are already deformed, wherein air flows are applied to the glass panes in at least one process step, the invention proposes that the air flows are combined of blown air and compressed air in a controlled manner.

The invention is related to a process of three-dimensional deformation of glass panes, which are heated up to the softening temperature in a first step, are deformed in a second step and are prestressed by means of targeted cooling in a third step. Further, the invention is related to a device of three-dimensional deformation of panels according to the process according to the invention.

In general, there is a high demand for three-dimensional deformed panels. To a great extent, three-dimensional deformed glass panes are needed far example in the automobile industry as well as in the architecture as construction glass. Nowadays, this demand extends to three-dimensional deformed panels made of other materials as well.

The technology of deformation of glass panes has developed chronological. Originally, glass panes have been deformed in so called vertical processes, for what purpose the glass panes to be deformed have been heated up vertically in furnaces and subsequently have been maintained and brought into in the vertical position with the help of clamps. To obtain safety glass, the surfaces have been cooled down.

In the course of time one has changed over to deform glass panes in so called horizontal processes, for what purpose the panels made of glass to be deformed are heated up to its softening temperature while lying in a furnace in a horizontal orientation. The softening temperature is the temperature, at which the material, out of which the panel to be deformed is made of, can be deformed plastically. In the beginning of the horizontal process the horizontally heated panels for example have been lifted and transported to a form with vacuum-evacuated caps by letting the panel drop onto the form. Due to gravity the panel has received the desired deformation. Subsequently, for cooling down the panel, substantially a frame is used as the form so that undesired deformations occurred in the center of the panels.

Also, the horizontally heated panels are fed to a bending station on rolls. So called roll hearth furnaces are used as furnaces, and the panels heated up to the softening temperature are then fed to the bending station on rolls, in particular ceramic rolls, for example according to U.S. Pat. No. 4,139,359. After deformation the panel is either cooled directly on the bending station or fed to a cooling station. In recent embodiments, the bending station consists substantially of molding members, which constitute a grill-like surface when arranged side by side, which surface corresponds to the desired form to be achieved by the deformation. According to a known process the horizontally heated glass panels are transported out of the furnace on horizontal rolls. Then, the horizontally arranged horizontal rolls are lowered, and the panel takes its position on the molding members providing the form. The pane is pressed onto the molding members by means of pressure rolls and receives the desired form. Subsequently, the formed pane is fed to a cooling station, which cooling station substantially consists of air nozzles, through which air nozzles cooling air is blown onto the surface of the pane.

For effecting these described processes it is known to connect the stations to one another or for example to integrate the bending station and the cooling station in one device, as for example known from EP-A1-0 263 030.

All of the known processes and devices operate according to one and the same principle. This principle says that firstly the whole panel to be deformed is heated up to its warming temperature, subsequently the whole panel is deformed on the deformation station and finally the whole panel is prestressed due to cooling. It is apparent that there is already a loss of heat in that time, in which the whole panel is brought from the furnace to the bending station. Since in particular glass panes need the same panel temperature both for deformation and for prestressing, the loss of heat has great impact on the quality of the obtained panels. Further, it is a drawback in terms of quality of the panels that with the horizontal processing the panels are transported from the furnace to the bending station in a horizontally lying manner on the mentioned ceramic rolls. Therefore, with respect to the transport direction the back parts of the panel remain longer inside the furnace than the front parts, on which front parts therefore the effect of the loss of heat is greater. Therefore when the panel arrives at the bending station it has different temperatures in different regions.

Much effort has been spent to overcome the drawbacks resulting from the loss of heat. On the one hand the panel has been heated up to excess temperatures. Since the change over to the zone of plastic deformation occurs fast, a too excessive temperature results in a fundamental waviness of the obtained panel when it is brought out of the furnace and transported to the bending station which consists substantially of rolls or molding members. This waviness yet occurs if the amount of temperature differences reaches 2° C. to 3° C. This result is not satisfactory where narrow tolerances are demanded, for example in the field of construction glass. Other effort to keep the panels warm, to postheat the panels or the like have been proved to be very costly and to not lead to satisfactory results.

A further problem according to the known processes and devices is the limitation regarding the radii to be formed. Due to the different temperatures of a glass panel of its front and back edge after leaving the furnace and being transported to the bending station, even cylinders cannot be formed with reasonable economic effort. In case it is desired to form very tight radii this can only be realized by successive deformations while tightening the radii. Due to the described loss of heat this is not possible with reasonable economic effort. It is nearly impossible to produce cone segments due to the different temperatures of the same panel on the one hand and the loss of heat on the other hand. If in particular in architecture very tight radii, very even cylinders or cone segments, for example for the design of a roof, are demanded, the desired glass forms are produced in individual processes with generally a high economic effort.

EP 0 634 371 A1 discloses a process for three-dimensional deformation of glass panes, which process overcomes the described drawbacks. In particular, the economic effort needed for deformation is supposed to be reduced to a great extent. Additionally, preferably even cylinders and tight radii are supposed to be formed without a great effort in terms of forms.

It is suggested to apply the process steps of heating, of deforming and of prestressing subsequently to individual successive treatment segments of the panel to be deformed, such that different treatment segments of the panel are treated in different process steps at the same time.

This process offers the advantage of effecting the deformation of the panels, in particular of glass panes, in a continuous operation. The panel is no longer heated as a whole, deformed as a whole and prestressed as a whole, but after reaching the desired softening temperature the panel is brought out of the furnace with its front edge with respect to the transport direction, such that the front edge is already deformed while the backmost segments of the panel are still heated inside the furnace. If the panel is further transported the following treatment segments are deformed while the front treatment segment is already prestressed by selective cooling. This process is continued until the back edge of the panel to be deformed has left the furnace with softening temperature, has been deformed and subsequently prestressed by selective cooling, while the front segments of the panel have already been deformed completely.

The notable advantage of this process is that the panel to be deformed has the same temperature in all segments, in which the panels is deformed. Just like that it is possible to form completely even cylinders. In addition, there are no differences in deformation between the front edge and the back edge of the panel. Since only a small panel segment has to be deformed directly after leaving the furnace, only very short deformation lines are required, therefore the process becoming much more economic.

Even though the described process leads to good results in general, it has turned out to have several drawbacks. On the one hand in the cooling station blown air is used in a conventional manner. Apart from a great demand for energy, an optimal control of the respective cooling process is not possible. Starting and shutting down takes a long time and involves a starting period. Further, the air blowers have to be operated and the pressure needed for the respective temperature transfer is limited. In addition, comparably big nozzles have to be provided.

A further drawback shows up when feeding a glass pane, which is bended around a bending line running in transport direction. This tends to buckle downwards when leaving the furnace.

A further drawback of the known device results from the use of bending rollers. For each desired bending form a further set of rollers has to be provided.

Coming from the described state of the art, it is an object of the present invention to improve the known process and to overcome the described drawbacks. In particular the use of air flows is to be improved.

As technical solution the invention proposes a process comprising the features of claim 1. Further advantages and features are characterized in the dependent claims.

On the device side the solution comprises a device with the features of claim 9. The depended claims characterize further advantages and features, too.

With the invention it is proposed that on the process side both blown air and compressed air are used. Both can be combined in any manner. The use of compressed air in the form of air generated by the compressor leads to the advantage, that it can be stored. Switching on and off is realized by opening and closing of a valve, preferably in the area of the respective nozzles, such that there is no time delay and hence the air can be controlled and can be applied in a targeted manner. In addition, a respective high pressure can be used so that an optimal temperature transfer results. Finally, the air nozzles for the compressed air can be constructed much smaller.

Both the direction and the pressure of the nozzles can be controlled. The blown air can be used permanently or can be turned on and can be combined in an optimal manner with the compressed air.

In the field of glass deformation devices, the use of compressed air is not known so far.

According to a further advantageous proposal of the invention it is provided that a bending line of the glass pane in kept at a constant level at least at the beginning of the deformation. It has turned out that with a deformation around a virtual axis, this means a round bending of a pane, deformations can occur in the area of the heated feeding area, if the heated area of the pane can for example buckle downwards due to gravity. Because of this the invention proposes to provide a support line. A bending line in this context is an area of the pane, which forms a lowermost deformation line in the feeding direction of the pane, therefore a lowermost plane of the material which results from bending around an axis that is parallel to the feeding direction.

According to an advantageous proposal a bar rack can be used for deformation.

In prior art an individual treatment or bending plane is provided by a forming, that means a pre-bended roller element. The respective area of the glass pane that runs on this roller is respectively bended in this bending plane. According to the present invention it is proposed to develop the individual bending plane as bars. Hence two or more bars together can define a respective bending plane. In an advantageous manner the bars can be adjustable relative to each other as to be adapted in a flexible manner to new forms. This is a further advantage over the prior art, as in prior art for each bending form new rollers had to be developed. Further it is proposed that the bars can be adjustable individually. The bars can be provided as pivotable rollers, which rollers can be driven. Hence the bar rack as a whole can be adapted to the respective individual case in a very flexible manner.

With the invention the processes known from prior art are improved to a great extend with simple means, without interfering or disadvantaging the industrial manufacture of respective bended panes.

On the device side it is proposed that the air nozzles can be used with blown air and for air from a compressor, this means compressed air. According to the invention, a compressed air storage is provided. According to the invention, the compressed air nozzles can be controlled with valves. The nozzles can be adjusted. Further, the air pressure can be adjusted.

By the use of a centralized control the nozzles and therefore the air can be used in an optimal way, in fact in terms of location as well as in terms of the direction of the pressure. With a respective high pressure when using compressed air, a respective good thermal transfer takes place.

In an advantageous manner the bending station comprises supporting elements for supporting a longitudinal center line of the glass pane. The longitudinal center line is substantially a bending line of a glass pane independent from its geometrical shape. In this area supporting elements, for example rolls, rollers or the like are arranged to avoid a folding respectively a buckling downward of the pane to be deformed in the respective area and to respectively support the bending line.

In an advantageous manner the bending station is designed as a bar rack. Therefore It is no longer needed to provide bending rollers for every form, but the desired form can be provided by a smart arrangement of the bars. In an advantageous manner a bending bed is provided by means of substantially horizontal basis bars and inclined side bars. All bars can be pivoted and adjusted so that almost any form and any shape run or bending run in the length direction of a bending station can be adjusted.

Further advantages and features will become apparent from the following description of the figures. The figures show:

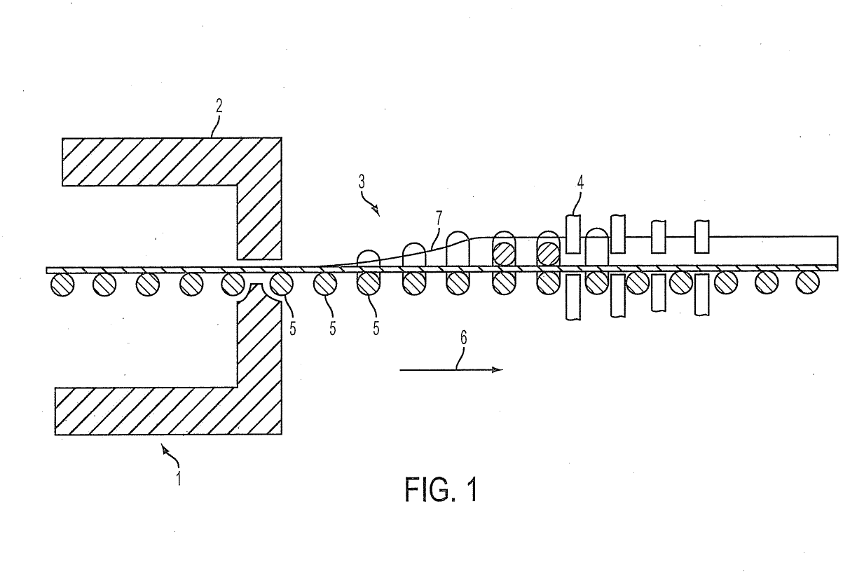

FIG. 1 a schematic side view of a glass deformation device;

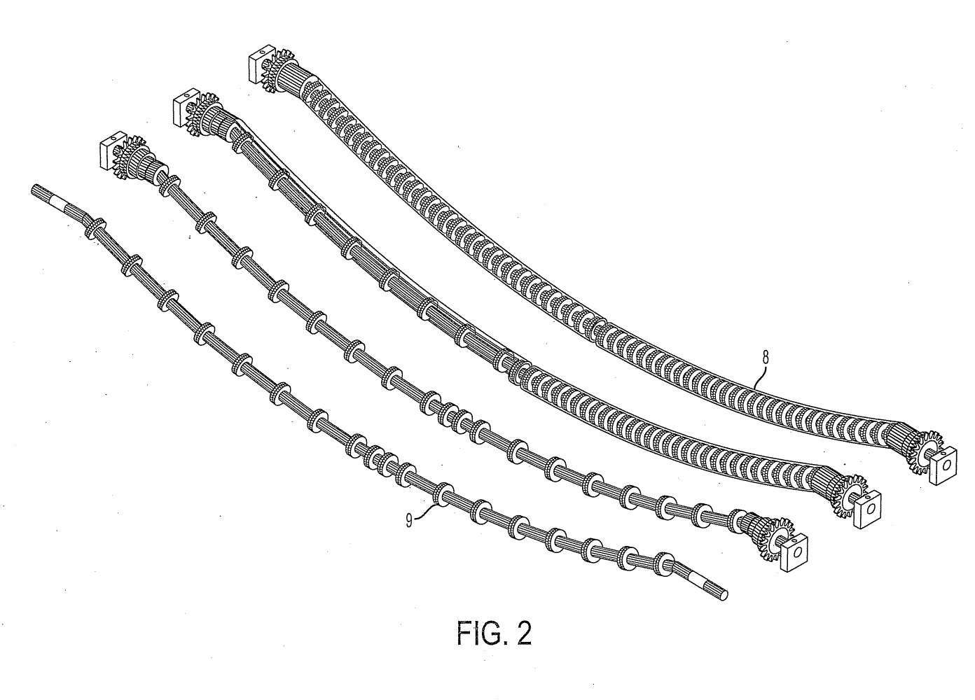

FIG. 2 a schematic view of bending rollers according to the prior art;

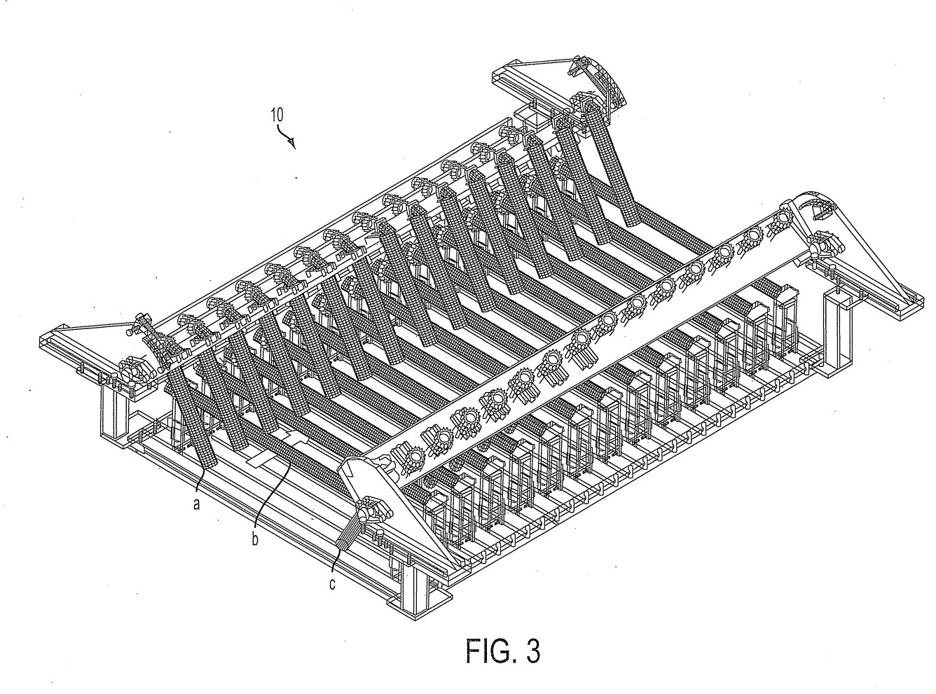

FIG. 3 a perspective partly sectional view of a bending station according to the invention;

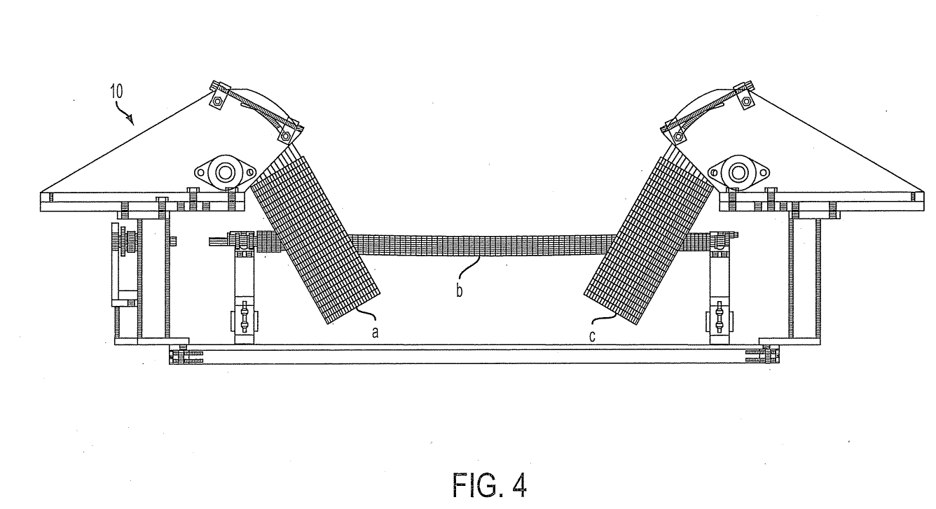

FIG. 4 a front view of the device according to FIG. 3;

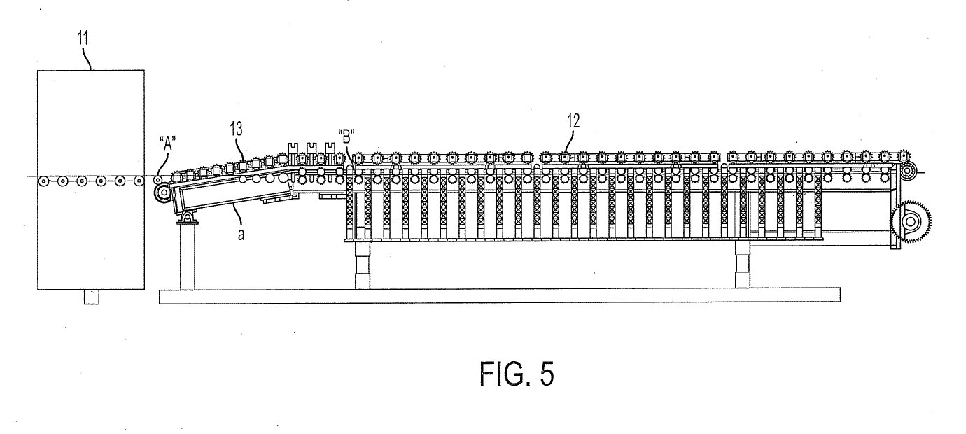

FIG. 5 a side view of a glass deformation device according to the invention and

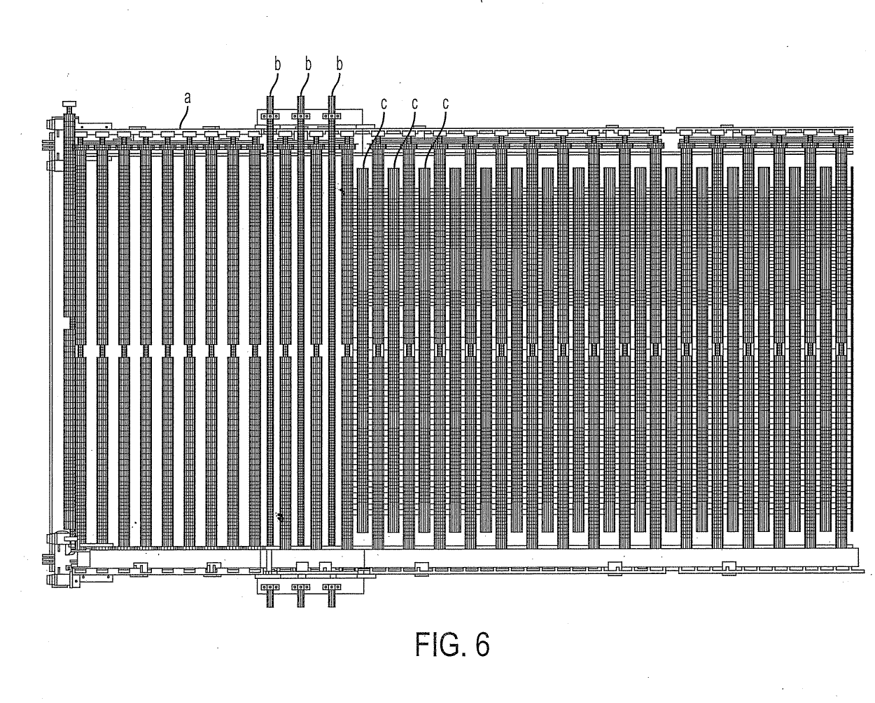

FIG. 6 a top view of a bending station according to the invention.

FIG. 1 shows a schematic side view of a deformation device 1 according to the invention, said deformation device consisting of a furnace 2, a bending station 3 and a cooling station 4. In the shown embodiment a panel 7 to be deformed is continuously transported in transport direction 6. Until the end of the heating process it has to be continuously in motion. The panel 7 is put horizontally on rolls 5 and is heated up to softening temperature in furnace 2, for example in the field of 630° C. While doing this the whole panel 7 can lay inside furnace 2 or only the respective treatment segment. After reaching the softening temperature of the panel or the segment, the panel is continuously transported, in what way the next segment is heated in the furnace, while at the same time the already heated segment is deformed in the bending station 3. In the shown embodiment the bending station 3 comprises several steps arranged in series so that the segments of the transported panel 7 are bended in the final desired radius, while backmost segments are still heated up to the softening temperature in the furnace. After leaving the last deformation step the finally deformed panel segment reaches the cooling station 4, where for example cooling air is blown onto the surface of the panel. It is obvious that with the device according to the invention implementing the process according to the invention deformed panels can be produced in an almost endless manner.

FIG. 2 shows schematically bending rollers according to the prior art. It turns out that these, whether they are full or just core rollers with roller rings, each must have a certain pre-forming. According to the prior art it was required to produce respectively use each of the respectively shaped rollers for the desired deformation operation. The rollers can for example be sheathed rollers 8, full rollers or only segmented rollers with roller rings 9. Each roller corresponds to a bending plane.

According to FIG. 3 an inventive embodiment of a bending station 10 is shown. In the shown embodiment the individual bending plane is composed of three roller segments, indicated with a, b and c. Although in the illustrated embodiment for purposes of illustration the roller segments are shown as even roller pieces, they can have respective bends or shapes. The side rollers a and c can be moved such that their angle of inclination changes. Then, also the free distance of the horizontal roller b changes which in turn can be adjusted in its height.

The rollers can be driven individually.

The front view according to FIG. 4 shows how a corresponding bending shape can be adjusted in the length direction of a roller bed. The inclination of the rollers a and c can be adjusted in the length direction so that a glass pane is bend open while it is transported from the beginning of the bending station to the end.

The rollers can be driven individually or in groups, depending on the respective task. With the embodiment of a bending station according to the invention three-dimensional deformed glass panes can be produced in a continuous manner.

FIG. 5 shows a side view of a device according to the invention. Leaving the furnace 11 the glass panes run up to a ramp 13 and then proceed to the bending station 12. A treatment plane is denoted with “A” and “B”, said treatment plane constituting the plane on which the pane is brought out of the furnace. The pane is then respectively bend in the deformation station, while it has shown up that it is crucial that the central area of the glass pane laying on the plane AB is always maintained on the same plane, the lowermost area of the bended glass pane in lifted and supported onto the treatment plane AB by means of the ramp 13. More corresponding support rollers are arranged in the remaining bending bed to ensure that in the center area a respective support takes place.

According to FIG. 6 air piping 15 is arranged in the bending area which comprises nozzles, through which nozzles compressed air can be released. The piping for the air which is generated by a centrifugal blower is denoted by 16 in FIG. 6. With these arrangements the thermal transfer coefficients are very high, the piping is smaller and it is possible to store compressed air in tanks.

The use of compressed air piping 15 is not known from the state of the art. As shown in FIG. 6, the compressed air piping 15 can be constructed much smaller than the piping 16 for the blown air. In addition the nozzles can be controlled individually or in groups, depending on the respective purpose. In addition the nozzles can be adjusted in terms of direction. The piping 15 is connected to a compressed air storage not shown. A control unit controls corresponding valves.

The arrangement of the blown air nozzles 16 allows the adjustment of the direction of the nozzles, too. In addition, here it is possible to provide die gaps. The blown air can be adjusted in terms of pressure in the scope of possibilities, but primarily serves for the known prestress.

With the use of the novel compressed air piping 15 a targeted treatment of the glass panes can be effected in this segment.

The described embodiments are illustrative only and are not descriptive.

### LISTING OF REFERENCE NUMERALS

1 deformation device
2 furnace
3 bending station
4 cooling station
5 rolls
6 transport direction
7 panel
8 rollers
9 roller rings
10 bending station
11 furnace
12 bending station
13 ramp
14 bending region
15 compressed air piping
16 air blower piping
a roller
b roller
c roller
A-B treatment plane

1. Process of three-dimensional deformation of glass panes, said glass panes
a) are heated up to the softening temperature in a first step
b) are deformed in a second step, and
c) are prestressed by means of targeted cooling in a third step,
wherein the process steps are subsequently applied to individual successive treatment segments of the panel to be deformed in such a manner that different subsequent treatment segments of the panel are treated effectively in another process step at the same time, wherein subsequent treatment segments for example are heated up to the processing temperature, while preceding treatment segments for example are already deformed, wherein air flows are applied to the glass panes in at least one process step,
characterized in
that the air flows are composed of blown air and compressed air in a controlled manner.

2. Process according to claim 1, characterized in that the air is blown onto the surfaces of the glass pane.

3. Process according to claim 1, characterized in that the air can be controlled in terms of temperature, pressure and/or direction.

4. Process according to claim 1, characterized in that the glass pane is maintained in a specific height along a virtual line in the area of a bending line at the beginning of the process.

5. Process according to claim 1, characterized in that the glass pane is moved on a bar rack for deformation.

6. Process according to claim 5, characterized in that the bars of the rack can be controlled individually or in groups.

7. Process according to claim 6, characterized in that the bars are adjustable.

8. Process according to claim 6, characterized in that the bars are configured as pivotable rollers.

9. A device for three-dimensional deformation of glass panes according to the process of claim 1, with a furnace, a bending station, a cooling station and a transport device, wherein the furnace, the bending station and the cooling station are arranged in this sequential arrangement and directly in series forming a transport path, along which transport path the panel to be deformed is transported continuously by means of the transport device, wherein the device comprises at least one air nozzle assembly comprising air nozzles, said air nozzle assembly can be operated in a controlled manner to output blown air and compressed air.

10. The device according to claim 9, characterized in that the air nozzles can be adjusted at least to some extent.

11. The device according to claim 9, characterized in that in the bending station supporting elements are arranged to support a longitudinal center line of the glass pane.

12. The device according to claim 9, characterized in that the bending station is formed as a bar rack.

13. The device according to claim 12, characterized in that the supporting elements are formed as roller elements that are arranged in the bar rack.

14. The device according to claim 13, characterized in that the bars are aligned as pivotable rollers.

15. The device according to claim 13, characterized in that individual bars are adjustable.

16. The device according to claim 15, characterized in that individual rollers can be driven.
